(19) United States
(12) Patent Application Publication
(10) Pub. No.: US 2006/0095261 A1
(43) Pub. Date: May 4, 2006

(54) Voice packet identification based on celp compression parameters

(75) Inventors: Debanjan Saha, Mohegan Lake, NY (US); Zon-Yin Shae, South Salem, NY (US)

Correspondence Address: FERENCE & ASSOCIATES, 409 BROAD STREET, PITTSBURGH, PA, 15143, US

(73) Assignee: IBM Corporation, Armonk, NY (US)

(21) Appl. No.: 10/978,055

(22) Filed: Oct. 30, 2004

(51) Int. Cl. G10L 17/00

(52) U.S. Cl. 704/246

(57) ABSTRACT

Mechanisms, and associated methods, for conducting voice analysis (e.g., speaker ID verification) directly from a compressed domain of a voice signal. Preferably, the feature vector is directly segmented, based on its corresponding physical meaning, from the compressed bit stream.

This invention was made with Government support under Contract No.: H98230-04-3-0001 awarded by the Distillery Phase II Program. The Government has certain rights in this invention.

### FIELD OF THE INVENTION

The present invention relates generally to voice signal production and processing.

### BACKGROUND OF THE INVENTION

Typically, in voice signal production and processing, a voice signal not only conveys speech content, but also reveals some information regarding speaker identity. In this respect, by analyzing the voice signal waveform, one can classify the voice signal into various categories, e.g., speaker ID, language ID, violent voice tone, and topic.

Traditionally, voice analysis is performed directly from the voice signal waveform. For example, for a conventional speaker ID verification system such as that shown in FIG. 1, the voice input 102 is first Fourier transformed into the frequency domain. After passing through a frequency spectrum energy calculation 106 and pre-emphasis processing (108) the frequency parameters are then passed through a set of mel-Scale logarithmic filters (110). The output energy of each individual filter is log-scaled (e.g., via a log-energy filter 112), before a cosine transform 114 is performed to obtain “cepstra”. The set of “cepstra” then serves as the feature vector for a vector classification algorithm, such as the GMM-UBM (Gaussian Mixture Model—Universal Background Model) for speaker ID verification (116). An example of the use of an algorithm such as that illustrated in FIG. 1 may be found in Douglas Reynolds, et. al., “Robust Text-Independent Speaker Identification Using Gaussian Mixture Speaker Models”, IEEE Transactions on Speech and audio processing, Vol. 3, No. 1, January 1995.

However, in a conventional arrangement, upon the onset of the VoIP (Voice over Internet Protocol), the voices are compressed and packetized and transported within the Internet. The traditional approach is to de-compress the voice packets into the voice signal waveform, then perform the analysis procedure described via FIG. 1. The approach shown in FIG. 1 would not work well if the packets are lost, e.g., due to network congestion. Particularly, if the packets become lost, then the de-compressed waveform will be distorted, the resulting feature vectors will be incorrect, and the analysis will be degraded dramatically. Moreover, the time to obtain a feature vector for the analysis will be very long due to the decompress-FFT-MeI-Sacle filter-Cosine transform (see Reynolds et al., supra). This will make a real time voice analysis very difficult.

In view of the foregoing, a need has been recognized in connection with attending to, and improving upon, the shortcomings and disadvantages presented by conventional arrangements.

### SUMMARY OF THE INVENTION

In accordance with at least one presently preferred embodiment of the present invention, there is broadly contemplated herein a mechanism for conducting voice analysis (e.g., speaker ID verification) directly from the compressed domain. Preferably, the feature vector is directly segmented, based on its corresponding physical meaning, from the compressed bit stream. This will eliminate the time consuming “decompress-FFT-MeI-Sacle filter-Cosine transform” process, to thus enable real time voice analysis directly from compressed bit streams. Moreover, the voice packet can be dropped due to Internet network congestion. Also, the computation power requirement is much higher if the system has to analysis of every compress voice packet. However, if some of the compress voice packets get dropped or sub-sampled, the decompressed voice will become highly distorted due to the correlation in the compressed packets in voice waveform and dramatically lose it properties for analysis. Accordingly, in accordance with at least one presently preferred embodiment of the present invention, analysis may be performed directly from the compress voice packets. This will allow the compressed voice data packets be sub-sampled at some constant (e.g., 10%) or variable rate in time. It will save the computation power requirement and also preserve voice packet properties of interest that would need to be analyzed.

In summary, one aspect of the invention provides an apparatus for voice signal analysis, said apparatus comprising: an arrangement for accepting a voice signal conveyed in compressed form; and an arrangement for conducting voice analysis directly from the compressed form of the voice signal.

Another aspect of the invention provides a method of voice signal analysis, said method comprising the steps of: accepting a voice signal conveyed in compressed form; and conducting voice analysis directly from the compressed form of the voice signal.

Furthermore, an additional aspect of the invention provides a program storage device readable by a machine, tangibly executable a program of instructions executable by the machine to perform method steps for voice signal analysis, said method comprising the steps of: accepting a voice signal conveyed in compressed form; and conducting voice analysis directly from the compressed form of the voice signal.

For a better understanding of the present invention, together with other and further features and advantages thereof, reference is made to the following description, taken in conjunction with the accompanying drawings, and the scope of the invention will be pointed out in the appended claims.

### BRIEF DESCRIPTION OF THE DRAWINGS

FIG. 1 is a block diagram depicting traditional speaker ID analysis.

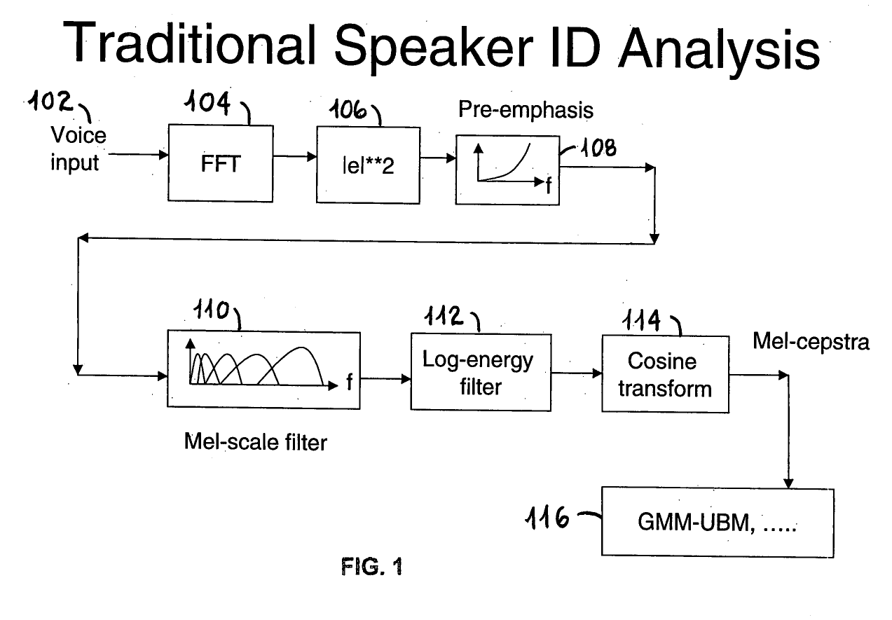

FIG. 2 is a block diagram depicting the application of a CELP G729 algorithm.

FIG. 3 depicts in tabular form a G729 bit stream format.

FIG. 4 sets forth a sample feature vector in a compressed stream.

### DESCRIPTION OF THE PREFERRED EMBODIMENTS

Though there is broadly contemplated in accordance with at least one presently preferred embodiment of the present invention an arrangement for generally conducting voice signal analysis from a compressed domain thereof, particularly favorable results are encountered in connection with analyzing a signal compressed via a CELP algorithm.

Indeed, modem voice compression is often based on a CELP algorithm, e.g., G723, G729, GSM. (See, e.g., Lajos Hanzo, et. al. “Voice Compression and Communications” John Wiley & Sons, Inc., Publication, ISBN 0-471-15039-8.) Basically, this algorithm models the human vocal tract as a set of filter coefficients, and the utterance is the result of a set of excitations going through the modeled vocal tract. Pitches in the voice are also captured. In accordance with at least one presently preferred embodiment of the present invention, packets that are compressed via a CELP algorithm are analyzed with highly favorable results.

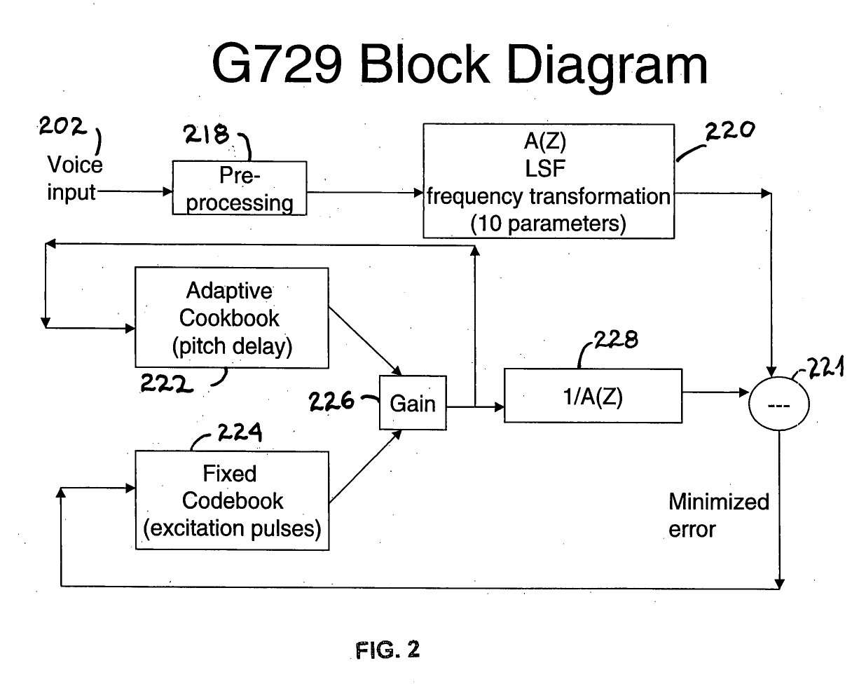

By way of an illustrative and non-restrictive example, a block diagram of a possible G729 compression algorithm is shown in FIG. 2. As shown, after pre-processing (218) of a voice input 202, an LSF frequency transformation is preferably undertaken (220). The difference between the output from 220 and from block 228 (see below) is calculated at 221. An adaptive codebook 222 is used to model long term pitch delay information, and a fix codebook 224 is used to model the short term excitation of the human speech. Gain block 226 is a parameter used to capture the amplitude of the speech, and block 220 is used to model the vocal track of the speaker, while block 228 is mathematically the reverse of the block 220.

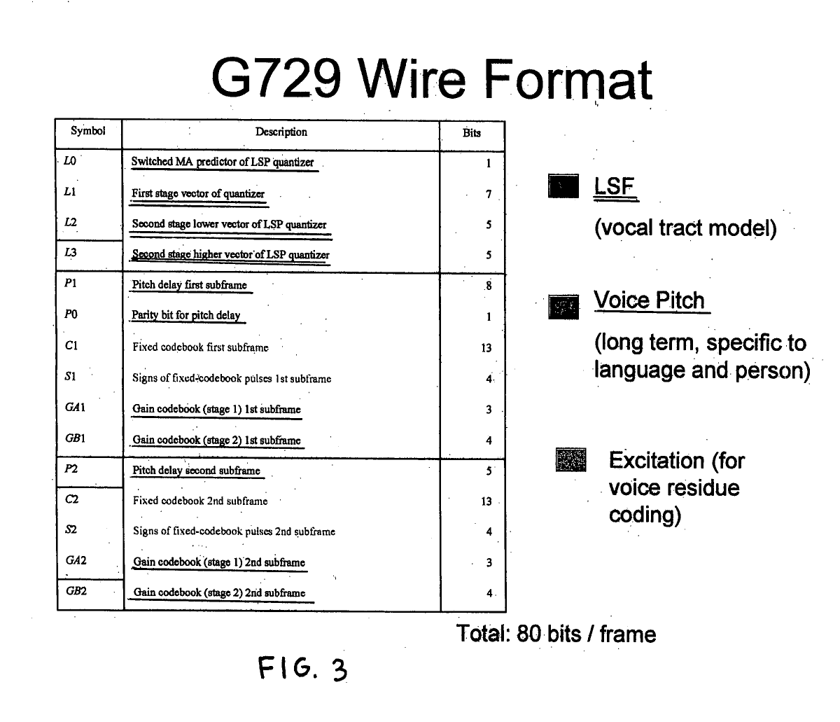

The compressed stream will explicitly carry this set of important voice characteristics in a different field of the bit stream. For example, a conceivable G729 bit stream is shown in FIG. 3. The corresponding physical meaning of each field is depicted via shading and single and double underlines, as shown.

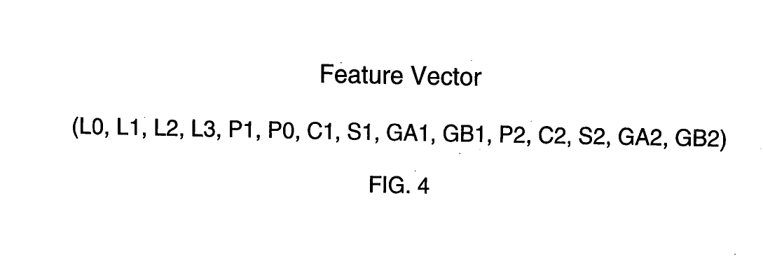

As shown in FIG. 3, important voice characteristics (e.g., voice tract filter model parameters, pitch delay, amplitude, excitation pulsed positions for the voice residues) for voice analysis (e.g., speaker ID verification) are all depicted. Accordingly, there is broadly contemplated in accordance with at least one presently preferred embodiment of the present invention a voice feature vector such as that shown in FIG. 4, segmented based on its corresponding physical meaning, for voice analysis directly in the compressed stream. L0, L1, L2, and L3 captured the vocal tract model of the speaker; P1, P0, GA1, GB1, P2, GA2 and GB2 capture the long term pitch information of the speaker; and C1, S1, C2, and S2 capture the short term excitation of the speech at hand.

It is to be understood that the present invention, in accordance with at least one presently preferred embodiment, includes an arrangement for accepting a voice signal conveyed in compressed form and an arrangement for conducting voice analysis directly from the compressed form of the voice signal. Together, these elements may be implemented on at least one general-purpose computer running suitable software programs. These may also be implemented on at least one Integrated Circuit or part of at least one Integrated Circuit. Thus, it is to be understood that the invention may be implemented in hardware, software, or a combination of both.

If not otherwise stated herein, it is to be assumed that all patents, patent applications, patent publications and other publications (including web-based publications) mentioned and cited herein are hereby fully incorporated by reference herein as if set forth in their entirety herein.

Although illustrative embodiments of the present invention have been described herein with reference to the accompanying drawings, it is to be understood that the invention is not limited to those precise embodiments, and that various other changes and modifications may be affected therein by one skilled in the art without departing from the scope or spirit of the invention.

What is claimed is:

1. An apparatus for voice signal analysis, said apparatus comprising:
an arrangement for accepting a voice signal conveyed in compressed form; and
an arrangement for conducting voice analysis directly from the compressed form of the voice signal.

2. The apparatus according to claim 1, wherein the voice signal is conveyed in packets.

3. The apparatus according to claim 2, wherein the voice signal is conveyed in packets via the Internet.

4. The apparatus according to claim 3, wherein the packets are conveyed in a packet stream, and the packet stream is sampled with a constant or variable rate in order to reduce the packet transmission rate prior to sending the packets onward for voice packet analysis.

5. The apparatus according to claim 1, further comprising an arrangement for discerning at least one characteristic in the voice signal associated with speaker identity.

6. The apparatus according to claim 1, wherein:
said accepting arrangement is adapted to accept a feature vector associated with the voice signal;
said arrangement for conducting voice analysis is adapted to segment the feature vector from a bit stream of the compressed form of the voice signal.

7. The apparatus according to claim 6, wherein said arrangement for conducting voice analysis is adapted to segment the feature vector based on a corresponding physical meaning.

8. The apparatus according to claim 1, wherein the compressed form of the voice signal has been compressed via a CELP algorithm.

9. The apparatus according to claim 8, wherein the CELP algorithm comprises a G729 algorithm.

10. A method of voice signal analysis, said method comprising the steps of:
accepting a voice signal conveyed in compressed form; and
conducting voice analysis directly from the compressed form of the voice signal.

11. The method according to claim 10, wherein the voice signal is conveyed in packets.

12. The method according to claim 11, wherein the voice signal is conveyed in packets via the Internet.

13. The method according to claim 12, wherein the packets are conveyed in a packet stream, and the packet stream is sampled with a constant or variable rate in order to reduce the packet transmission rate prior to sending the packets onward for voice packet analysis.

14. The method according to claim 10, further comprising the step of discerning at least one characteristic in the voice signal associated with speaker identity.

15. The method according to claim 10, wherein:
said accepting step comprises accepting a feature vector associated with the voice signal;
said step of conducting voice analysis comprises segmenting the feature vector from a bit stream of the compressed form of the voice signal.

16. The method according to claim 15, wherein said step of conducting voice analysis comprises segmenting the feature vector based on a corresponding physical meaning.

17. The method according to claim 10, wherein the compressed form of the voice signal has been compressed via a CELP algorithm.

18. The apparatus according to claim 17, wherein the CELP algorithm comprises a G729 algorithm.

19. A program storage device readable by a machine, tangibly executable a program of instructions executable by the machine to perform method steps for voice signal analysis, said method comprising the steps of:
accepting a voice signal conveyed in compressed form; and
conducting voice analysis directly from the compressed form of the voice signal.
